(19) United States
(12) Patent Application Publication
(10) Pub. No.: US 2025/0276535 A1
(43) Pub. Date: Sep. 4, 2025

(54) DRYING DEVICE AND RECORDING DEVICE

(71) Applicant: SEIKO EPSON CORPORATION, Tokyo (JP)

(72) Inventor: Tadashi AIZAWA, MATSUMOTO-SHI (JP)

(21) Appl. No.: 19/065,207

(22) Filed: Feb. 27, 2025

(30) Foreign Application Priority Data
Mar. 1, 2024 (JP) 2024-031076

(51) Int. Cl. B41J 11/00; B41J 15/04; B41M 7/00

(52) U.S. Cl. CPC B41J 11/00218; B41J 15/048; B41M 7/0081

(57) ABSTRACT

A drying device includes a drying section that dries a medium onto which liquid was ejected by generating an electromagnetic wave in response to application of a high-frequency voltage. The drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode. The first electrode extends in a second direction intersecting the first direction. The second electrode includes an opening section that surrounds the first electrode, and the opening section has a long side in the second direction and a short side in a third direction intersecting the first direction and the second direction. A first distance between the first electrode and the short side of the opening section in the second direction is longer than a second distance between the first electrode and the long side of the opening section in the third direction.

The present application is based on, and claims priority from JP Application Serial Number 2024-031076, filed Mar. 1, 2024, the disclosure of which is hereby incorporated by reference herein in its entirety.

### BACKGROUND

### 1. Technical Field

The present disclosure relates to a drying device and a recording device.

### 2. Related Art

For example, JP-A-2019-155811 discloses a drying device that dries a medium by generating electromagnetic waves toward a medium onto which liquid was ejected. Such a drying device generates an electromagnetic wave with respect to a medium by supplying a high-frequency voltage between a first electrode and a second electrode. By this, a medium onto which liquid was ejected can be dried.

However, in such a drying device, there is a possibility that the drying degree of a medium becomes uneven. For this reason, it is desired to equalize the drying degree of a medium.

### SUMMARY

A drying device to overcome the above-described problem includes a drying section that dries a medium, onto which liquid was ejected, by generating an electromagnetic wave in response to application of a high-frequency voltage, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode, the first electrode extends in a second direction intersecting the first direction, the second electrode includes an opening section that surrounds the first electrode, the opening section has a long side in the second direction and a short side in a third direction intersecting the first direction and the second direction, and a first distance between the first electrode and the short side of the opening section in the second direction is longer than a second distance between the first electrode and the long side of the opening section in the third direction.

A recording device to overcome the above-described problem includes a recording section that performs recording by ejecting liquid onto a medium and a drying section that dries a medium onto which liquid was ejected by the recording section by generating an electromagnetic wave in response to application of a high-frequency voltage, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode, the first electrode extends in a second direction intersecting the first direction, the second electrode includes an opening section that surrounds the first electrode, the opening section has a long side in the second direction and a short side in a third direction intersecting the first direction and the second direction, and a first distance between the first electrode and the short side of the opening section in the second direction is longer than a second distance between the first electrode and the long side of the opening section in the third direction.

### BRIEF DESCRIPTION OF THE DRAWINGS

FIG. 1 is a schematic diagram showing a recording system of a first embodiment.

FIG. 2 is a perspective view showing a drying section of the first embodiment.

FIG. 3 is a schematic diagram showing the drying section of the first embodiment.

FIG. 4 is a schematic diagram showing drying sections of the first embodiment.

FIG. 5 is a perspective view showing a drying section of a second embodiment.

FIG. 6 is a schematic diagram showing a drying section of a modification.

### DESCRIPTION OF EMBODIMENTS

### First Embodiment

Hereinafter, an embodiment of a recording system including a drying device and a recording device will be described. In the following description, a direction intersecting a vertical direction Z is referred to as a width direction X, and a direction intersecting the vertical direction Z and the width direction X is referred to as a depth direction Y. One direction along the width direction X is referred to as a first width direction X1, and the other direction along the width direction X is referred to as a second width direction X2. One direction along the depth direction Y is referred to as a first depth direction Y1, and the other direction along the depth direction Y is referred to as a second depth direction Y2. In the vertical direction Z, an upper direction is referred to as an upper direction Z1, and a lower direction is referred to as a lower direction Z2. The vertical direction Z corresponds to an example of a first direction. The width direction X corresponds to an example of a second direction. The depth direction Y corresponds to an example of a third direction.

### Configuration of Recording System 10

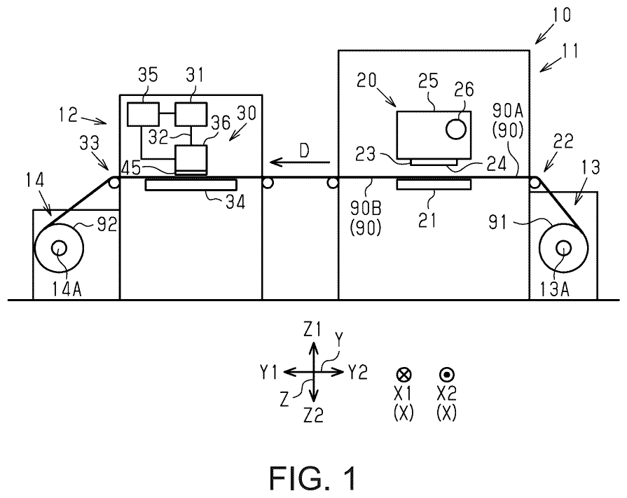

As shown in FIG. 1, a recording system 10 is a system that performs recording on a medium 90. In particular, the recording system 10 is a system that performs recording on the medium 90 by ejecting liquid onto the medium 90. The recording system 10 is a system that dries the medium 90 after recording onto which liquid was ejected.

The recording system 10 includes a recording device 11. The recording device 11 is configured to perform recording on the medium 90. In particular, the recording device 11 performs recording on the medium 90 by ejecting liquid onto the medium 90. The recording device 11 may be an inkjet type printer that performs recording by ejecting ink, which is an example of liquid, onto the medium 90. The medium 90 includes a front surface 90A and a back surface 90B. The medium 90 is fabric, but may be, for example, paper.

The recording system 10 includes a drying device 12. The drying device 12 is configured to dry the medium 90 after recording onto which the recording device 11 ejected liquid. In particular, the drying device 12 generates an electromagnetic wave to dry the medium 90 after recording.

The recording system 10 includes a feeding section 13. The feeding section 13 feeds the medium 90 before recording to the recording device 11. The feeding section 13 includes a feed roller 13A. The feed roller 13A extends along the width direction X. In the width direction X, the width of the feed roller 13A is longer than the width of the medium 90. The feed roller 13A is configured to rotatably hold a first roll body 91. The first roll body 91 is the medium 90 before recording that is wound and stacked. The medium 90 may be elongated. In this way, the feed roller 13A holds the medium 90 to be fed to the recording device 11.

The recording system 10 includes a winding section 14. The winding section 14 winds up the medium 90 after recording by the recording device 11. In particular, the winding section 14 winds up the medium 90 after recording and drying by the drying device 12. The winding section 14 includes a winding roller 14A. The winding roller 14A extends along the width direction X. In the width direction X, the width of the winding roller 14A is longer than the width of the medium 90. The winding roller 14A is configured to rotatably hold a second roll body 92. The second roll body 92 is the medium 90 after recording that is wound and stacked. In this way, the winding roller 14A winds up the medium 90 that was recorded by the recording device 11 and dried by the drying device 12.

### Configuration of Recording Device 11

Here, the configuration of the recording device 11 will be described in detail.

The recording device 11 includes a recording section 20, a recording support section 21, and a recording transport section 22. The recording section 20 is configured to perform recording on the medium 90 by ejecting liquid onto the medium 90. The recording section 20 is configured to perform recording on the medium 90 by ejecting liquid onto the front surface 90A of the medium 90. The recording section 20 performs recording on the medium 90 supported by the recording support section 21. The recording section 20 performs recording on the medium 90 transported by the recording transport section 22.

The recording section 20 includes a head 23. The head 23 may be a serial head or may be a line head. A serial head is a head that scans in the width direction X of the medium 90. A line head is a head that records simultaneously across the width direction X of the medium 90.

The head 23 includes a nozzle surface 24 in which nozzles (not shown) are opened. The nozzle surface 24 is a surface facing the lower direction Z2. The nozzle surface 24 is a surface facing the front surface 90A of the medium 90 transported by the recording transport section 22. Each of the plurality of nozzles is configured to open up in the lower direction Z2. Each of the plurality of nozzles is configured to eject liquid.

The recording section 20 may include a carriage 25 and a carriage support section 26. The carriage 25 is configured to support the head 23. The carriage support section 26 extends along the width direction X. The carriage support section 26 supports the carriage 25 so as to be movable along the width direction X. The carriage 25 is movable in the width direction X along the carriage support section 26 by a driving force from a drive source (not shown).

The recording support section 21 is configured to support the medium 90 transported by the recording transport section 22. The recording support section 21 is positioned in the lower direction Z2 of the recording section 20. The recording support section 21 supports the back surface 90B of the medium 90 transported by the recording transport section 22. The recording support section 21 is positioned in the lower direction Z2 of the head 23.

The recording transport section 22 is configured to transport the medium 90 in a transport direction D. The transport direction D is a direction along the depth direction Y. The recording transport section 22 may include a plurality of rollers. Although the recording transport section 22 transports the medium 90 in the transport direction D using the plurality of rollers, the recording transport section 22 may transport the medium 90 in the transport direction D using a transport belt driven by a plurality of rollers. The recording transport section 22 may perform intermittent transport in which the transport and stop of the medium 90 are repeated.

Configuration of drying device 12

Next, the configuration of the drying device 12 will be described in detail.

The drying device 12 includes a drying unit 30. The drying unit 30 is configured to dry the medium 90 after recording. That is, the drying device 12 sets the medium 90 on which recording is performed by the recording section 20 as an object to be dried.

The drying unit 30 is configured to dry the medium 90 after recording by generation of electromagnetic waves. The drying unit 30 is positioned in the upper direction Z1 of the medium 90, but may be positioned in the lower direction Z2 of the medium 90, or may be positioned both in the upper direction Z1 and in the lower direction Z2 of the medium 90. In this way, the vertical direction Z is a direction toward the medium 90.

The drying device 12 includes a high-frequency voltage generation section 31. The high-frequency voltage generation section 31 is configured to generate a high-frequency voltage. The high-frequency voltage generation section 31 supplies a high-frequency voltage to the drying unit 30 through a transmission line 32.

The transmission line 32 is a line for connecting the drying unit 30 and the high-frequency voltage generation section 31. The transmission line 32 is capable of transmitting a high-frequency voltage from the high-frequency voltage generation section 31 to the drying unit 30. That is, the transmission line 32 is capable of transmitting a high-frequency voltage.

The transmission line 32 may be a coaxial cable, but is not limited to coaxial cable. The transmission line 32 may include a first line and a second line. The first line may be a core line of the transmission line 32. The second line may be an electromagnetic shield that covers the first line.

The drying device 12 includes a drying transport section 33. The drying transport section 33 is configured to transport the medium 90 in the transport direction D. The drying transport section 33 functions as an example of a movement section that relatively moves the medium 90 with respect to the drying section 36 (to be described later). The transport direction D is a direction along the depth direction Y. The transport direction D corresponds to an example of a relative movement direction.

The drying transport section 33 may transport the medium 90 in the transport direction D using a plurality of rollers. The drying transport section 33 may perform continuous transport in which the medium 90 is continuously transported. Slackening of the medium 90 may occur between the recording transport section 22 and the drying transport section 33.

The drying device 12 includes a drying support section 34. The drying support section 34 is configured to support the medium 90 transported by the drying transport section 33. The drying support section 34 is positioned in the lower direction Z2 of the drying unit 30. The drying support section 34 supports the back surface 90B of the medium 90 transported by the drying transport section 33. The drying support section 34 is positioned in the lower direction 22 of the drying section 36 (to be described later).

The drying device 12 includes a control section 35. The control section 35 controls the drying device 12. Specifically, the control section 35 controls the drying unit 30. The control section 35 controls the high-frequency voltage generation section 31. The control section 35 controls the drying transport section 33.

The control section 35 may be constituted by one or more processors that execute various processes in accordance with a computer program. The control section 35 may be composed of one or more dedicated hardware circuits. The control section 35 may be configured with an application specific integrated circuit that executes at least a part of various processes. The control section 35 may be composed of a processor and a circuit including a combination of hardware circuits. The processor includes a CPU and memories such as a RAM and a ROM. The memory stores program codes or commands configured to cause the CPU to perform processes. Memory, that is computer-readable medium, includes any readable medium that can be accessed by a general-purpose or dedicated computer.

The drying unit 30 includes a drying section 36. That is, the drying device 12 includes the drying section 36. The drying unit 30 may include a plurality of drying sections 36. The drying section 36 may have a rectangular shape in plan view from the vertical direction Z. The drying section 36 may be arranged so that the width direction X is a longitudinal direction. Hereinafter, plan view from the vertical direction Z is simply referred to as plan view.

The drying section 36 is configured to generate an electromagnetic wave in response to application of a high-frequency voltage. The section drying 36 generates an electromagnetic wave in response to application of a high-frequency voltage. By this, the drying section 36 is configured to dry the medium 90 onto which liquid was ejected by the recording section 20. The drying section 36 is an electromagnetic wave generation section.

The drying section 36 generates an alternating current electric field by generating an electromagnetic wave. An electromagnetic wave generated by the drying section 36 has an electric field as a main component. The drying section 36 can significantly reduce induction of a magnetic field due to a generated electric field as compared with an electromagnetic wave generation section that generates a normal electromagnetic wave.

As a specific example, the drying section 36 generates electromagnetic waves of 2.4 GHz, but is not limited to this. The drying section 36 may generate, for example, electromagnetic waves of 3 MHz to 300 MHz. The drying section 36, for example, may generate electromagnetic waves of 300 MHz to 30 GHz, and among these, may generate electromagnetic waves of 10 MHz to 20 GHz.

The drying section 36 dries the medium 90 by heating the medium 90 from the front surface 90A. Specifically, the drying section 36 heats liquid ejected onto the medium 90 from the front surface 90A. The drying section 36 dries the medium 90 by vaporizing liquid ejected onto the medium 90. That is, the drying section 36 is a method of drying the medium 90 regardless of whether or not water vapor is saturated around the medium 90. Therefore, the drying section 36 does not need to blow dry gas in which water vapor is not saturated around the medium 90.

### Configuration of Drying Section 36

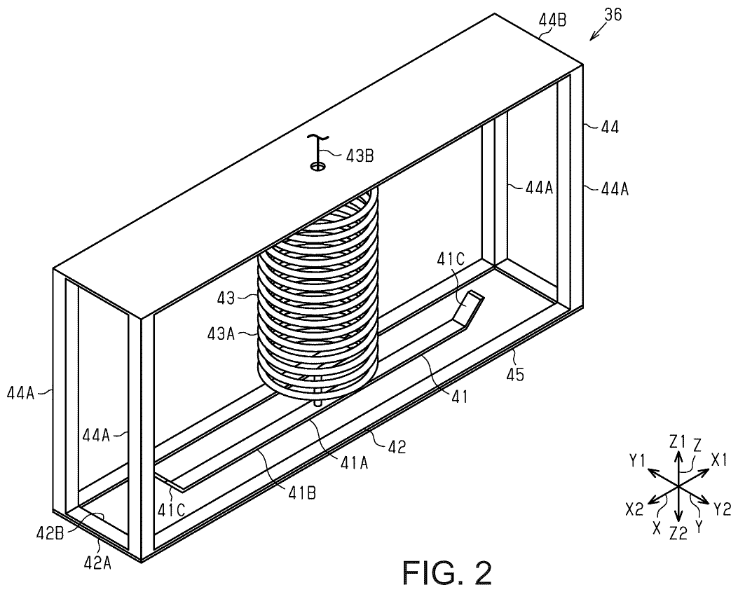

As shown in FIG. 2, the drying section 36 includes a first electrode 41, a second electrode 42, a first conductor 43, and a second conductor 44. The drying section 36 may include a facing section 45. FIG. 2 is a view in which the first electrode 41 and second electrode 42 are arranged on a lower direction Z2 side.

The first electrode 41 has a flat plate shape, but may have a rod shape. The first electrode 41 is elongated in the width direction X in plan view. That is, the first electrode 41 extends in the width direction X in plan view. The first electrode 41 may have a rectangular shape in plan view.

The first electrode 41 includes a first electrode surface 41A. The first electrode surface 41A is a surface facing the lower direction Z2. That is, the first electrode surface 41A is a surface facing the front surface 90A of the medium 90. The first electrode 41 is arranged such that the first electrode surface 41A abuts the facing section 45.

The first electrode 41 includes a central section 41B and both end sections 41C. The central section 41B is a section positioned at the center in the width direction X. Both end sections 41C are sections positioned at both ends in the width direction X. The central section 41B and both end sections 41C are provided integrally.

The central section 41B constitutes the first electrode surface 41A. The central section 41B is provided at a position overlapping with the second electrode 42 in the vertical direction Z. That is, at least a part of the first electrode 41 is provided at a position overlapping with the second electrode 42 in the vertical direction Z.

Both end sections 41C are configured to be upwardly inclined with respect to the outside in the width direction X. Both end sections 41C are positioned away from the facing section 45. That is, both end sections 41C extend in the upper direction Z1 away from the medium 90 in the vertical direction Z. Both end sections 41C may be curved away from the facing section 45.

The second electrode 42 has a flat plate shape. The second electrode 42 includes a second electrode surface 42A. The second electrode surface 42A is a surface facing the lower direction Z2. That is, the second electrode surface 42A is a surface facing the front surface 90A of the medium 90. The second electrode 42 is arranged such that the second electrode surface 42A abuts the facing section 45.

The second electrode 42 includes an opening section 42B. The opening section 42B has a rectangular shape in plan view, but may have a rectangular shape with rounded corners. The first electrode 41 is positioned in the opening section 42B in plan view. The opening section 42B surrounds the first electrode 41 in plan view. That is, the second electrode 42 is arranged so as to surround the first electrode 41 in plan view.

The first conductor 43 is configured to electrically connect the transmission line 32 and the first electrode 41. The first conductor 43 includes a coil 43A. The coil 43A extends in the vertical direction Z. One end of the coil 43A is connected to the first electrode 41. The other end of the coil 43A is connected to a conductor wire 43B.

The second conductor 44 is configured to electrically connect the transmission line 32 and the second electrode 42. The second conductor 44 may include a columnar support 44A. The second conductor 44 may include a plurality of columnar supports 44A. The columnar supports 44A are electrically connected to the second electrode 42. The columnar support 44A extends from the second electrode 42 in the upper direction Z1. The columnar support 44A is made of metal.

The second conductor 44 may include a top plate 44B. The top plate 44B is electrically connected to the columnar supports 44A. The top plate 44B is provided at an upper end section of the columnar supports 44A. The top plate 44B connects a plurality of the columnar supports 44A. The top plate 44B may be integrated with the columnar support 44A. The top plate 44B is made of metal.

The facing section 45 is positioned between the first electrode 41 and the second electrode 42, and the medium 90. The facing section 45 may have a flat plate shape. The facing section 45 is made of a material that transmits electromagnetic waves generated by the drying section 36. The facing section 45 is arranged so as to face the front surface 90A of the medium 90. The facing section 45 may not be in contact with the medium 90, and may be in contact with the medium 90. The facing section 45 protects the first electrode 41 and the second electrode 42. The facing section 45 is composed of a member having insulating properties. The facing section 45 may be a glass plate. The facing section 45 may be a ceramic with high transmittance. The facing section 45 may be made of a resin with a low dissipation factor. The facing section 45 may be made of polypropylene. The facing section 45 may be made of polyethylene.

By configuring the drying section 36 in this manner, when a high-frequency voltage is applied, the first electrode 41 and the second electrode 42 heat the medium 90 by generating an electromagnetic wave in response to application of a high-frequency voltage.

Such a drying section 36 can transmit a large amount of thermal energy to the medium 90 due to generation of electromagnetic waves. The drying section 36 is not of a thermal conduction type but of an electromagnetic wave type, and does not need to include a member such as a heating wire for heating. This allows the drying section 36 to be made smaller in size.

The minimum separation distance between the first electrode 41 and the second electrode 42 is equal to or less than 1/10 of the wavelength of an electromagnetic wave output from the drying section 36. By this, electromagnetic waves generated when a high-frequency voltage is applied can be attenuated in the vicinity of the first electrode 41 and the second electrode 42. By this, it is possible to reduce the intensity of an electromagnetic wave that reaches a distant place from the first electrode 41 and the second electrode 42. That is, an electromagnetic wave generated from the drying section 36 is very strong in the vicinity of the first electrode 41 and the second electrode 42, and is very weak in a distant place.

Such a drying section 36 can intensively generate an alternating current electric field in the vicinity of the first electrode 41 and the second electrode 42 by appropriately controlling the frequency band of an electromagnetic wave to be generated. In other words, it is possible to suppress the influence on the surroundings accompanying the generation of electromagnetic waves beyond the vicinity of the first electrode 41 and the second electrode 42. The vicinity of the first electrode 41 and the second electrode 42 may correspond to a range of, for example, 3 mm to 3 cm.

Configurations of first electrode 41 and second electrode 42

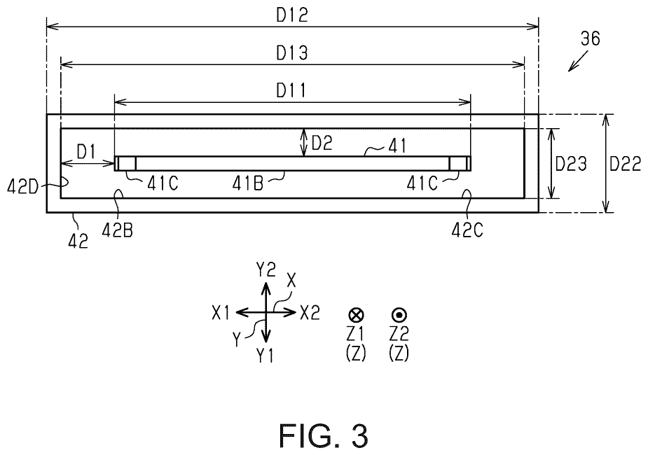

As shown in FIG. 3, the first electrode 41 is provided so as to have the length of a distance D11 in the width direction X. The second electrode 42 is provided so as to have the length of a distance D12 in the width direction X and the length of a distance D22 in the depth direction Y. The distance D12 is longer than the distance D22.

The opening section 42B is provided so as to have the length of a distance D13 in the width direction X and the length of a distance D23 in the depth direction Y. The distance D13 is longer than the distance D23. In this manner, the opening section 42B is provided such that the width direction X corresponds to a long side 42C and the depth direction Y corresponds to a short side 42D. The opening section 42B may be provided such that the distance D23, which is the length of the short side 42D, is one-third or less of the distance D13, which is the length of the long side 42C. The distance D23 may be one-third or less of the distance D11.

A distance between the first electrode 41 and the short side 42D in the width direction X is a first distance D1. A distance between the first electrode 41 and the long side 42C in the depth direction Y is a second distance D2. The first distance D1 is longer than the second distance D2. By configuring the first electrode 41 and the second electrode 42 in this manner, it is possible to weaken an electric field generated between both end sections 41C and the short side 42D of the first electrode 41. Specifically, since both end sections 41C of the first electrode 41 are inclined in the upper direction Z1, an electromagnetic wave with respect to the medium 90 can be weakened. By making the first distance D1 longer than the second distance D2, it is possible to weaken an electromagnetic wave with respect to the medium 90. By this, it is possible to suppress the concentration of a strong electric field region at both end sections 41C of the first electrode 41 and to suppress unevenness of the drying degree of the medium 90.

### Arrangement of Drying Section 36

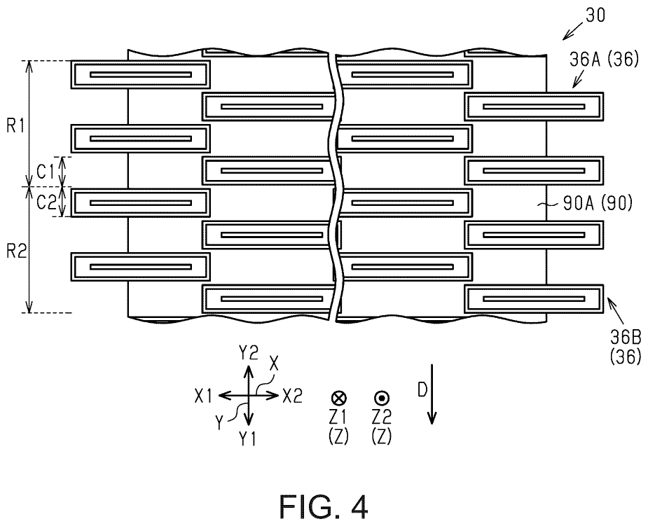

As shown in FIG. 4, when the drying unit 30 includes a plurality of the drying sections 36, the plurality of the drying sections 36 may be arranged in the width direction X, and the plurality of the drying sections 36 may be arranged in the depth direction Y. In this case, a plurality of the drying sections 36 may be arranged across the entire width of the medium 90 in the width direction X. In this manner, a plurality of the drying sections 36 is arranged so as to be aligned in the width direction X. A plurality of the drying sections 36 is arranged so as to be aligned in the depth direction Y.

A plurality of the drying sections 36 includes first drying sections 36A and second drying sections 36B. The first drying section 36A and the second drying section 36B may generate an electromagnetic wave having different intensities. The first drying section 36A generates an stronger electromagnetic wave than the second drying section 36B, but may also generate a weaker electromagnetic wave than the second drying section 36B.

Specifically, by configuring the inductance of the coil 43A of the first drying section 36A to be different from the inductance of the coil 43A of the second drying section 36B, the resonance frequency of the first drying section 36A can be made different from the resonance frequency of the second drying section 36B.

As described above, the first drying section 36A and the second drying section 36B have different resonance frequencies. As a specific example, a plurality of the first drying sections 36A in a first row C1 and a plurality of second drying sections 36B in a second row C2 have different resonance frequencies.

The first drying section 36A is arranged in a first region R1. The second drying section 36B is arranged in a second region R2. The first region R1 is a region positioned on an upstream side in the transport direction D. The second region R2 is a region positioned on a downstream side in the transport direction D. That is, the second region R2 is a region positioned on a downstream side of the first region R1 in the transport direction D.

In the first region R1, the drying sections 36 are arranged in the same number of rows as in the second region R2 in the depth direction Y. The number of rows of the drying sections 36 arranged in the first region R1 in the depth direction Y may be smaller than that in the second region R2. The number of rows of the drying sections 36 arranged in the first region R1 in the depth direction Y may be larger than that in the second region R2.

The plurality of the drying sections 36 is arranged so as to be aligned in the width direction X in each row. As a specific example, a plurality of the drying sections 36 is arranged so as to be aligned in the width direction X in the first row C1. A plurality of the drying sections 36 is arranged so as to be aligned in the width direction X in the second row C2. The first row C1 and the second row C2 may be rows that are adjacent to each other in the depth direction Y.

In this way, a plurality of the drying sections 36 in the first row C1 and a plurality of the drying sections 36 in the second row C2 is arranged so as to be aligned in the depth direction Y. A plurality of the drying sections 36 in the first row C1 and a plurality of the drying sections 36 in the second row C2 is arranged such that their positions in the width direction X are different.

As a specific example, a case where the medium 90 on which pigment ink is ejected as liquid is dried will be described. Pigment ink includes a pigment, water, and a solvent. The solvent may include, for example, glycerin. Glycerin is a solvent for preventing clogging of a nozzle that ejects liquid. Due to the vaporization of glycerin, the abrasion resistance of the medium 90 onto which pigment ink was ejected is improved.

When drying the medium 90 onto which pigment ink was ejected, provisional drying and main drying are performed. Provisional drying vaporizes water contained in pigment ink at approximately 100° C. In such a case, it is desirable to rapidly increase the temperature of pigment ink.

Main drying is performed after provisional drying. Main drying vaporizes a solvent contained in pigment ink at approximately 300° C. In main drying, it is desirable to maintain the temperature of pigment ink without excessively increasing the temperature in order to increase the reliability of vaporization of glycerin without causing thermal denaturation of the medium 90. It is desirable that main drying is performed for a longer time than provisional drying.

For this reason, the first drying section 36A generates an electromagnetic wave that are stronger than that of the second drying section 36B. In the first region R1, the drying sections 36 are arranged in a smaller number of rows in the depth direction Y than in the second region R2.

In provisional drying, the first drying section 36A generates an electromagnetic wave stronger than that of the second drying section 36B, so that the temperature can be rapidly increased. Thereafter, in main drying, the temperature of the second drying section 36B can be maintained without being excessively increased.

The medium 90 is transported in the transport direction D at a constant speed. Therefore, in a case where the number of rows of the drying sections 36 arranged in the first region R1 is smaller than the number of rows of the drying sections 36 arranged in the second region R2, it is possible to make the time for drying by the second drying section 36B arranged in the second region R2 longer than the time for drying by the first drying section 36A arranged in the first region R1.

For example, as the medium 90 dries, the amount of water contained in medium 90 decreases. As described above, when the water content of the medium 90 containing water having a high dielectric constant decreases, the relative dielectric constant decreases. Therefore, it is desirable that the resonance frequency is changed stepwise in the transport direction D.

### Operations and Effects of First Embodiment

Operations and effects of the first embodiment will be described.

(1-1) In the related art, the first electrode extends in the width direction X, and a strong electric field region tends to be concentrated in nearby regions of both end sections of the first electrode, for example, by the same principle as that of corona discharge. Therefore, the heating amount is large in the nearby regions of both end sections of the first electrode, but the heating amount is small in the other region. By this, since the heating amount becomes uneven depending on a region, the drying degree of the medium 90 becomes uneven.

Therefore, the first distance D1 between the first electrode 41 and the short side 42D of the opening section 42B in the width direction X is longer than the second distance D2 between the first electrode 41 and the long side 42C of the opening section 42B in the depth direction Y. According to this configuration, it is possible to avoid the concentration of electromagnetic waves at both end sections 41C of the first electrode 41. By this, electromagnetic waves to be generated can be equalized. Therefore, unevenness in the drying degree of the medium 90 can be suppressed.

(1-2) A plurality of the drying sections 36 is arranged so as to be aligned in the depth direction Y. According to this configuration, by arranging the plurality of the drying sections 36 so as to be aligned in the depth direction Y, it is possible to suppress a decrease in the drying efficiency of the medium 90.

(1-3) A plurality of the drying sections 36 is arranged so as to be aligned in the width direction X. According to this configuration, by arranging the plurality of the drying sections 36 so as to be aligned in the width direction X, it is possible to suppress a decrease in the drying efficiency of the medium 90.

(1-4) A plurality of the drying sections 36 is arranged so as to be aligned in the width direction X in the first row C1, and a plurality of the drying sections 36 is arranged so as to be aligned in the width direction X in the second row C2 adjacent to the first row C1 in the depth direction Y. A plurality of the drying sections 36 in the first row C1 and a plurality of the drying sections 36 in the second row C2 is arranged such that their positions in the width direction X are different. According to this configuration, by arranging the plurality of the drying sections 36 so as to be aligned in both the width direction X and the depth direction Y, it is possible to suppress a decrease in the drying efficiency of the medium 90. In addition, since the drying sections 36 in the first row C1 and the drying sections 36 in the second row C2 are arranged at different positions in the width direction X, it is possible to suppress unevenness of the drying degree of the medium 90.

(1-5) A part of the first electrode 41 is provided at a position overlapping with the second electrode 42 in the vertical direction Z. According to this configuration, both the first electrode 41 and the second electrode 42 can have the same distance from the medium 90 in the vertical direction Z. Therefore, a decrease in the drying efficiency of the medium 90 can be suppressed.

(1-6) The first electrode 41 includes the central section 41B in the width direction X and both end sections 41C in the width direction X. Both end sections 41C extend in the upper direction Z1 away from the medium 90 in the vertical direction Z. According to this configuration, it is possible to avoid the concentration of electromagnetic waves at both end sections 41C of the first electrode 41. By this, electromagnetic waves to be generated can be equalized. Therefore, unevenness in the drying degree of the medium 90 can be suppressed.

(1-7) The central section 41B and both end sections 41C are provided integrally. According to this configuration, since the central section 41B and both end sections 41C are provided integrally, a high-frequency voltage can be efficiently transmitted. Therefore, a decrease in the drying efficiency of the medium 90 can be suppressed.

(1-8) The drying transport section 33 relatively moves the medium 90 along the depth direction Y with respect to the drying section 36. According to this configuration, it is possible to relatively move the medium 90 with respect to the drying section 36 along the depth direction Y, which intersects the width direction X that is the longitudinal direction of the first electrode 41 and the opening section 42B. By this, a region to be dried can be widened in the width direction X that does not depend on the relative movement of the medium 90 with respect to the drying section 36. Therefore, unevenness in the drying degree of the medium 90 can be suppressed.

(1-9) A plurality of the first drying sections 36A is arranged in the first row C1 so as to be aligned in the width direction X. A plurality of the second drying sections 36B is arranged in the second row C2 so as to be aligned in the width direction X. The plurality of the first drying sections 36A in the first row C1 and the plurality of the second drying sections 36B in the second row C2 have different resonance frequencies. According to this configuration, resonance frequencies can be made different between the plurality of the first drying sections 36A in the first row C1 and the plurality of the second drying sections 36B in the second row C2 arranged in the depth direction Y in which the medium 90 relatively moves with respect to the drying section 36. Therefore, the drying degree of the medium 90 can be adjusted.

### Second Embodiment

Next, a second embodiment will be described. In the following description, the same configuration as that of the embodiment already described will be omitted or simplified, and a configuration different from that of the embodiment already described will be described.

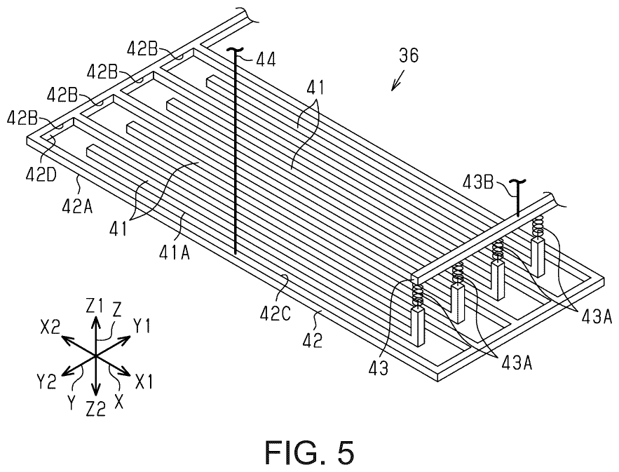

As shown in FIG. 5, in the second embodiment, the second electrode 42 includes a plurality of the opening sections 42B. In the width direction X, the second electrode 42 may be longer than the width of the medium 90. In the width direction X, the long side 42C of the opening section 42B may be longer than the width of the medium 90.

The drying section 36 includes a plurality of first electrodes 41 and the first conductors 43. Each of the plurality of the first electrodes 41 is arranged so as to be surrounded by the plurality of the opening sections 42B. In the width direction X, each of the plurality of the first electrodes 41 may be longer than the width of the medium 90. The distances between the first electrode 41 and the short side 42D in the width direction X are longer than the distances between the first electrode 41 and the long side 42C in the depth direction Y.

The drying transport section 33 relatively moves the medium 90 along the depth direction Y with respect to the drying section 36. The relative movement direction is a direction along the depth direction Y. That is, the width direction X intersecting the transport direction D is a longitudinal direction of the drying section 36.

Thus, the drying section 36 according to the second embodiment is configured to include the plurality of the drying sections 36 according to the first embodiment. Specifically, the drying section 36 according to the second embodiment is configured such that the first electrode 41 and the second electrode 42 are elongated in the width direction X. In the drying section 36 according to the second embodiment, a plurality of the second electrodes 42 arranged in the depth direction Y according to the first embodiment are integrally configured.

### Operations and Effects of Second Embodiment

Operations and effects of the second embodiment will be described.

(2-1) In the width direction X, the long sides 42C of the opening sections 42B are longer than the width of the medium 90, and the first electrodes 41 are longer than the width of the medium 90. According to this configuration, it is possible to relatively move the medium 90 with respect to the drying section 36 along the depth direction Y, which intersects the width direction X that is the longitudinal direction of the first electrode 41 and the opening section 42B. By this, a region to be dried can be widened in the width direction X that does not depend on the relative movement of the medium 90 with respect to the drying section 36. Therefore, unevenness in the drying degree of the medium 90 can be suppressed.

### Modifications

The present embodiment can be implemented with the following modifications. The present embodiment and the following modifications can be implemented in combination with each other within a technically compatible range.

In the second embodiment, the drying transport section 33 may relatively move the medium 90 along the width direction X with respect to the drying section 36. The relative movement direction is a direction along the width direction X. That is, the width direction X along the transport direction D is a longitudinal direction of the drying section 36.

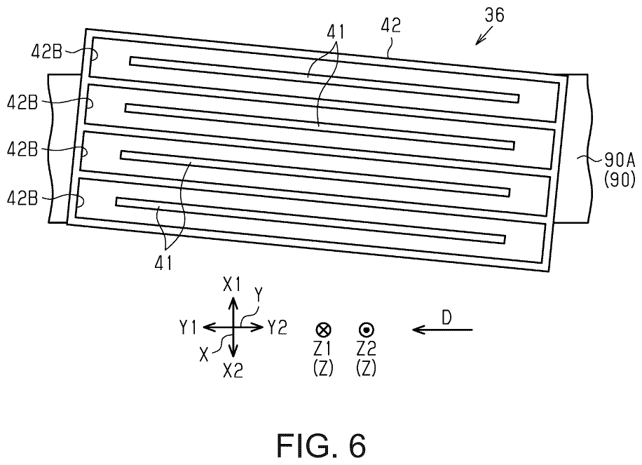

In the second embodiment, as shown in FIG. 6, in a case where the drying transport section 33 relatively moves the medium 90 along the depth direction Y with respect to the drying section 36, a direction inclined with respect to the width direction X and the depth direction Y may be a longitudinal direction of the drying section 36. The relative movement direction is a direction inclined with respect to the width direction X and the depth direction Y.

As described above, the relative movement direction in which the medium 90 is relatively moved with respect to the drying section 36 is a direction inclined with respect to the width direction X. According to this configuration, even in a case where the medium 90 is relatively moved in the relative movement direction inclined with respect to the width direction X, it is possible to continuously dry the medium 90. Therefore, unevenness in the drying degree of the medium 90 can be suppressed.

The drying device 12 may include a movement section that moves the drying section 36. The drying device 12 may include a movement section that moves both the drying section 36 and the medium 90. In this manner, a movement section may be configured to relatively move the medium 90 with respect to the drying section 36.

In the first embodiment, the plurality of the first drying sections 36A in the first row C1 and the plurality of the second drying sections 36B in the second row C2 may not be adjacent to each other in the depth direction Y. That is, in the depth direction Y, the drying section 36 in another row may be arranged between the plurality of the first drying sections 36A in the first row C1 and the plurality of the second drying sections 36B in the second row C2.

The first electrode 41 may be inclined in the upper direction Z1 so as to branch both end sections 41C. Both end sections 41C of the first electrode 41 need not be inclined in the upper direction Z1. That is, both end sections 41C may be provided at the same positions as the central section 41B in the vertical direction Z. In this way, the first electrode 41 is provided at a position overlapping with the second electrode 42 in the vertical direction Z.

The drying section 36 may be arranged so that the depth direction Y is a longitudinal direction. That is, the depth direction Y may be an example of the second direction. The width direction X may be an example of the third direction. The drying section 36 may be arranged so as to be inclined with respect to the width direction X and the depth direction Y. A direction inclined with respect to the width direction X and the depth direction Y may be an example of the second direction.

The drying unit 30 may include one or more drying sections 36. A plurality of the drying sections 36 may be arranged in a plurality of rows in the width direction X. A plurality of the drying sections 36 may be arranged in a plurality of rows in the depth direction Y.

The drying section 36 may be provided on a back surface 90B side of the medium 90. The drying section 36 may be provided on both a front surface 90A side of the medium 90 and a back surface 90B side of the medium 90. The drying section 36 may be capable of scanning in the width direction X.

The drying section 36 may be provided separately from the facing section 45. That is, the drying section 36 may not include the facing section 45. In this case, it is desirable for the facing section 45 to be provided between the first electrode 41 and the second electrode 42, and the medium 90.

The first electrode 41 is not limited to a flat plate shape and may, for example, have a substantially flat plate shape. The substantially flat shape may include, for example, a shape curved in the thickness direction, which is a direction along the vertical direction Z, or a linear shape with an extremely large aspect ratio of a rectangular shape.

The second electrode 42 is not limited to a flat plate shape and may, for example, have a substantially flat plate shape. The substantially flat shape may include, for example, a shape curved in the thickness direction, which is a direction along the vertical direction Z, or a linear shape with an extremely large aspect ratio of a rectangular shape.

At least one of the first electrode surface 41A and the second electrode surface 42A is not limited to a planar shape and may be a substantially planar shape. The substantially planar shape may include, for example, a shape curved in the thickness direction, which is a direction along the vertical direction Z, or a linear shape with an extremely large aspect ratio of a rectangular shape.

The drying section 36 may not be provided in the drying device 12 and may be provided in the recording device 11. That is, the recording device 11 may include the drying section 36. In this case, it is sufficient that the drying section 36 is provided on a downstream side of the recording section 20 in the transport direction D. In this manner, the drying section 36 may be applied to the recording device 11 instead of the drying device 12.

A lateral type printer may be adopted as the recording device 11. The lateral type printer is a printer in which the carriage 25 can move in two directions, a main scanning direction and a sub-scanning direction.

The medium 90 is not limited to a roll body. The medium 90 may be a paper sheet, a resin film or sheet, a resin-metal composite film, a laminate film, a textile, a nonwoven fabric, a metal foil, a metal film, a ceramic sheet, a garment, or the like.

Liquid can be arbitrarily selected as long as it can perform recording on the medium 90 by depositing to medium 90. For example, ink includes ink in which particles of a functional material made of a solid material such as pigment or a metal particle are dissolved, dispersed, or mixed in a solvent, and includes various compositions such as water-based ink, oil-based ink, gel ink, and hot melt ink.

As used herein, the phrase “at least any” means one or more of the desired options. As an example, the phrase “at least any” as used herein means only one option if the number of options is two, or both of the two options. As another example, the phrase “at least any” as used herein means only one option or a combination of any two or more options when the number of options is three or more.

### Notes

Hereinafter, technical ideas grasped from the above-described embodiments and modifications, and operations and effects thereof will be described. The present technical ideas and the operations and effects thereof can be combined with each other within a technically consistent range.

(A) A drying device includes a drying section that dries a medium, onto which liquid was ejected, by generating an electromagnetic wave in response to application of a high-frequency voltage, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode, the first electrode extends in a second direction intersecting the first direction, the second electrode includes an opening section that surrounds the first electrode, the opening section has a long side in the second direction and a short side in a third direction intersecting the first direction and the second direction, and a first distance between the first electrode and the short side of the opening section in the second direction is longer than a second distance between the first electrode and the long side of the opening section in the third direction.

According to this configuration, the first electrode extends in the second direction, and the first distance between the first electrode and the short side of the opening section in the second direction is longer than the second distance between the first electrode and the long side of the opening section in the third direction. Therefore, it is possible to avoid the concentration of electromagnetic waves at both end sections of the first electrode. By this, electromagnetic waves to be generated can be equalized. Therefore, unevenness in the drying degree of the medium can be suppressed.

(B) The above-described drying device may be configured such that a plurality of the drying sections is arranged so as to be aligned in the third direction.

According to this configuration, by arranging the plurality of the drying sections so as to be aligned in the third direction, it is possible to suppress a decrease in the drying efficiency of the medium.

(C) The above-described drying device may be configured such that a plurality of the drying sections is arranged so as to be aligned in the second direction.

According to this configuration, by arranging the plurality of the drying sections so as to be aligned in the second direction, it is possible to suppress a decrease in the drying efficiency of the medium.

(D) The above-described drying device may be configured such that a plurality of the drying sections is arranged so as to be aligned in the second direction in a first row, a plurality of the drying sections is arranged so as to be aligned in the second direction in a second row adjacent to the first row in the third direction, and the plurality of the drying sections in the first row and the plurality of the drying sections in the second row are arranged at different positions in the second direction.

According to this configuration, by arranging the plurality of the drying sections so as to be aligned in both the second direction and the third direction, it is possible to suppress a decrease in the drying efficiency of the medium. In addition, since the plurality of the drying sections in the first row and the plurality of the drying sections in the second row are arranged at different positions in the second direction, it is possible to suppress unevenness in the drying degree of the medium.

(E) The above-described drying device may be configured such that the opening section is provided so that a length of the short side is one-third or less of a length of the long side.

According to this configuration, it is possible to achieve the same effect as (A).

(F) The above-described drying device may be configured such that the first electrode is provided at a position overlapping with the second electrode in the first direction.

According to this configuration, both the first

electrode and the second electrode can have the same distance from the medium in the first direction. Therefore, it is possible to suppress a decrease in the drying efficiency of the medium.

(G) The above-described drying device may be configured such that the first electrode includes a central section in the second direction and both end sections in the second direction and the both end sections extend in a direction away from a medium in the first direction.

According to this configuration, it is possible to avoid the concentration of electromagnetic waves at both end sections of the first electrode. By this, electromagnetic waves to be generated can be equalized. Therefore, unevenness in the drying degree of the medium can be suppressed.

(H) The above-described drying device may be configured such that the central section and the both end sections are provided integrally.

According to this configuration, since the central section and both end sections are provided integrally, a high-frequency voltage can be efficiently transmitted. Therefore, it is possible to suppress a decrease in the drying efficiency of the medium.

(I) The above-described drying device may be configured such that the drying device further includes a movement section that relatively moves a medium along the third direction with respect to the drying section.

According to this configuration, it is possible to relatively move the medium with respect to the drying section along the third direction which intersects the second direction, which is a longitudinal direction of the first electrode and the opening section. By this, it is possible to widen a region to be dried in the second direction, which does not depend on the medium being relatively moved with respect to the drying section. Therefore, unevenness in the drying degree of the medium can be suppressed.

(J) The above-described drying device may be configured such that a plurality of the drying sections is arranged so as to be aligned in the second direction in a first row, a plurality of the drying sections is arranged so as to be aligned in the second direction in a second row, and the plurality of the drying sections in the first row and the plurality of the drying sections in the second row have different resonance frequencies.

According to this configuration, the resonance frequencies can be made different between the plurality of the drying sections in the first row and the plurality of the drying sections in the second row, which are arranged in the third direction in which the medium relatively moves with respect to the drying sections. Therefore, the drying degree of the medium can be adjusted.

(K) The above-described drying device may be configured such that the drying device further includes a movement section that relatively moves a medium along a relative movement direction with respect to the drying section, wherein the relative movement direction is a direction that has an inclination with respect to the second direction.

According to this configuration, even when the medium is moved in the relative movement direction, the medium can be continuously dried. Therefore, unevenness in the drying degree of the medium can be suppressed.

(L) A recording device includes a recording section that performs recording by ejecting liquid onto a medium and a drying section that dries a medium onto which liquid was ejected by the recording section by generating an electromagnetic wave in response to application of a high-frequency voltage, wherein the drying section includes a first electrode, a second electrode arranged so as to surround the first electrode in plan view from a first direction toward a medium, a first conductor that includes a coil and that electrically connects a transmission line, which is configured to transmit a high-frequency voltage, and the first electrode, and a second conductor that electrically connects the transmission line and the second electrode, the first electrode extends in a second direction intersecting the first direction, the second electrode includes an opening section that surrounds the first electrode, the opening section has a long side in the second direction and a short side in a third direction intersecting the first direction and the second direction, and a first distance between the first electrode and the short side of the opening section in the second direction is longer than a second distance between the first electrode and the long side of the opening section in the third direction.

According to this configuration, it is possible to achieve the same effect as (A).

What is claimed is:

1. A drying device comprising:
a drying section that dries a medium, onto which liquid was ejected, by generating an electromagnetic wave in response to application of a high-frequency voltage, wherein
the drying section includes
a first electrode,
a second electrode arranged so as to surround the first electrode in plan view from a first direction toward a medium,
a first conductor that includes a coil and that electrically connects a transmission line, which is configured to transmit a high-frequency voltage, and the first electrode, and
a second conductor that electrically connects the transmission line and the second electrode,
the first electrode extends in a second direction intersecting the first direction,
the second electrode includes an opening section that surrounds the first electrode,
the opening section has a long side in the second direction and a short side in a third direction intersecting the first direction and the second direction, and
a first distance between the first electrode and the short side of the opening section in the second direction is longer than a second distance between the first electrode and the long side of the opening section in the third direction.

2. The drying device according to claim 1, wherein
a plurality of the drying sections is arranged so as to be aligned in the third direction.

3. The drying device according to claim 1, wherein
a plurality of the drying sections is arranged so as to be aligned in the second direction.

4. The drying device according to claim 1, wherein
a plurality of the drying sections is arranged so as to be aligned in the second direction in a first row,
a plurality of the drying sections is arranged so as to be aligned in the second direction in a second row adjacent to the first row in the third direction, and
the plurality of the drying sections in the first row and the plurality of the drying sections in the second row are arranged at different positions in the second direction.

5. The drying device according to claim 1, wherein
the opening section is provided so that a length of the short side is one-third or less of a length of the long side.

6. The drying device according to claim 1, wherein
the first electrode is provided at a position overlapping with the second electrode in the first direction.

7. The drying device according to claim 1, wherein
the first electrode includes a central section in the second direction and both end sections in the second direction and
the both end sections extend in a direction away from a medium in the first direction.

8. The drying device according to claim 7, wherein
the central section and the both end sections are provided integrally.

9. The drying device according to claim 1, further comprising:
a movement section that relatively moves a medium along the third direction with respect to the drying section.

10. The drying device according to claim 9, wherein
a plurality of the drying sections is arranged so as to be aligned in the second direction in a first row,
a plurality of the drying sections is arranged so as to be aligned in the second direction in a second row, and
the plurality of the drying sections in the first row and the plurality of the drying sections in the second row have different resonance frequencies.

11. The drying device according to claim 1, further comprising:
a movement section that relatively moves a medium along a relative movement direction with respect to the drying section, wherein
the relative movement direction is a direction that has an inclination with respect to the second direction.

12. A recording device comprising:
a recording section that performs recording by ejecting liquid onto a medium and
a drying section that dries a medium onto which liquid was ejected by the recording section by generating an electromagnetic wave in response to application of a high-frequency voltage, wherein
the drying section includes
a first electrode,
a second electrode arranged so as to surround the first electrode in plan view from a first direction toward a medium,
a first conductor that includes a coil and that electrically connects a transmission line, which is configured to transmit a high-frequency voltage, and the first electrode, and
a second conductor that electrically connects the transmission line and the second electrode,
the first electrode extends in a second direction intersecting the first direction,
the second electrode includes an opening section that surrounds the first electrode,
the opening section has a long side in the second direction and a short side in a third direction intersecting the first direction and the second direction, and
a first distance between the first electrode and the short side of the opening section in the second direction is longer than a second distance between the first electrode and the long side of the opening section in the third direction.
